(19) United States
(12) Patent Application Publication
(10) Pub. No.: US 2005/0244624 A1
(43) Pub. Date: Nov. 3, 2005

(54) Wet process chopped fiber mat production

(76) Inventor: Michel Droux, La Ravoire (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/505,166

(22) PCT Filed: Mar. 5, 2003
(86) PCT No.: PCT/FR03/00701

§ 371 Date: Jun. 27, 2005

(30) Foreign Application Priority Data
Mar. 6, 2002 (FR) 02/02833

(51) Int. Cl. B32B 1/00; D04H 3/00; D04H 3/14

(52) U.S. Cl. 428/219; 162/156; 442/331; 442/410; 428/220

(57) ABSTRACT

The invention relates to a process for manufacturing a chopped strand mat that can be used for the reinforcement of thermosetting resins. The process comprises a step of dispersing strands, that are chopped and dried after sizing with a sizing liquid comprising an organosilane and a film former, in a white water, then a step of forming a web by passing the dispersion over a forming wire, through which the white water is drained, the strands being retained on said wire, then a step of applying a binder and then a heat treatment step. Chopped strand mats with a uniform mass per unit area of generally between 50 and 1100 g/m² are obtained. A few chopped strands are broken down into filaments within the mat.

The invention relates to a process for manufacturing a chopped strand mat by a wet route. Such mats are normally manufactured by a dry route using processes that are not very productive (low machine speed and low machine output) which also result in mats of low grammage and in somewhat irregular grammage.

In the mat according to the invention, the aim is to ensure that the individual filaments are assembled as far as possible in the form of strands. The aim is therefore to minimize the amount of individual filaments.

U.S. Pat. No. 6,291,552 has proposed a wet process in which the chopped strands are firstly broken down into filaments, the filaments obtained then being reagglomerated using flocculating agents contained in the white water. This process therefore requires a particular white water formulation and in addition the reagglomeration is not uniform.

WO 01/75204 provides a process for preparing a tissue mat by a wet route in which the fibers are sized by an epoxy resin or a PVOH, the sizing not being dried between its application to the fibers and the use of said fibers in the process for manufacturing the tissue mat. This process leads to a fabric having weakly reinforcing properties, especially with regard to polyester resins. In addition, a small proportion of the chopped strands remains in the form of chopped strands in the white water, most of them being broken down into filaments during the process. Finally, this wet process does not operate with a fiber content in the white water of greater than 0.05% by weight.

As documents of the prior art, mention may also be made of WO 98/11299, U.S. Pat. No. 4,118,272, U.S. Pat. No. 4,242,404, U.S. Pat. No. 4,112,174, WO 99/45198, U.S. Pat. No. 6,054,022.

The invention solves the abovementioned problems. The process according to the invention comprises:
a step of dispersing, in a white water, chopped strands that are dried after sizing with a sizing liquid comprising an organosilane and a film former; then
a step of forming a web by passing the dispersion over a forming wire through which the white water is drained, the strands being retained on said wire; then
a step of applying a binder; and then
a heat treatment step.

The dried chopped strands used within the process according to the invention therefore undergo the following manufacturing steps:
a step of sizing the strands using a liquid comprising an organosilane and a film former; then
a step of drying the sized strands; and then
a step of chopping the dried sized strands.

The organosilane preferably contains at least one carbon-carbon double bond.

The organosilane used during sizing is generally the hydrolyzed derivative of an alkoxysilane, which itself generally contains the trialkoxysilane group, i.e. —Si(OR)₃, R representing a hydrocarbon radical such as a methyl or ethyl or propyl or butyl radical. The organosilane may therefore be the hydrolyzed derivative of one of the following compounds:
methacrylic alkoxysilane;
3-methacryloxypropyltrimethoxysilane;
vinylalkoxysilane;
vinyltriethoxysilane;
tris(2-methoxyethoxy)vinylsilane;
arylaminoalkoxysilane;
alkoxyaminosilane;
3-aminopropyltriethoxysilane;
N-(2-aminoethyl)-3-aminopropyltrimethoxysilane;
2-(3,4-epoxycyclohexyl)ethyltrimethoxysilane;
3-glycidoxypropyltrimethoxysilane;
epoxyalkoxysilane;
triacetoxyvinylalkoxysilanesilane.

The organosilane is generally present in the sizing liquid in an amount from 0.05% to 1% by weight and preferably from 0.2 to 0.6% by weight.

The film former may be chosen from the following list:
homopolyvinyl acetate;
silane/vinyl acetate copolymer;
epoxide/polyvinyl acetate copolymer;
polyvinyl acetate-N-methylolacrylamide copolymer;
epoxy-polyester;
polyester;
polyurethane;
epoxy polymer;
epoxy-polyurethane copolymer;
vinyl acetate/ethylene copolymer;
copolymer of styrene with at least one acrylate.

It is also possible to use one of the film formers mentioned in “The Manufacturing technology of continuous glass fibers” by K. Loewenstein, Glass Science and Technology 6, Elsevier, 1983.

The film former preferably has a molecular mass of between 10000 and 100000. Preferably, after drying at 105° C. for two hours the film former has a solubility in acetone at 20° C. ranging from 50 to 95%.

The film former is generally present in the sizing liquid in an amount from 2 to 10% and preferably 3 to 6% by weight. If the film former is a polyvinyl acetate, the sizing liquid also preferably includes a plasticizer, such as dibutyl phthalate or diethylene glycol dibenzoate.

The sizing liquid also preferably includes a lubricant, which may, for example, be chosen from the following list:
fatty-chain quaternary ammonium salt;
alkyl ether;
mineral oil.

The lubricant may be present in the sizing liquid in an amount from 0.05 to 1% and preferably 0.2 to 0.6% by weight. If a fatty-chain quaternary ammonium salt is used as lubricant, this compound also acts as an antistatic agent.

The sizing liquid may also include an antistatic agent, which may be a fatty-chain quaternary ammonium salt. The antistatic agent may be present in the sizing liquid in an amount from 0 to 1%.

After sizing, the strands are generally wound into a roll, in order to form cakes, which may be stored in the wet state. The wet strand may then be unwound before being dried and then chopped.

After sizing, it is also possible to dry the strands continuously, then to wind them to form a dry cake, which can also be stored. The dried strand can then be unwound before being chopped.

It is also possible to carry out the succession of sizing, drying and chopping steps continuously, without intermediate storage.

In respect of the step of drying the sized strands, these are heated so that they contain less than 0.2% water by weight, and preferably less than 0.1% water by weight. This heat treatment is generally carried out at between 90 and 140° C. If the sized strands had been put in the form of wet cakes, this heat treatment may be carried out by heating the wet cakes of sized strands in an oven heated to 130° C., generally for a time of at least 10 hours, for example from 12 to 24 hours. The residual water content in the strands may be measured by gravimetric analysis, by measuring the weight loss at 105° C. of 10 grams of a sized strand.

After drying, the strands are chopped, generally to a length ranging from 20 mm to 110 mm, preferably from 25 to 60 mm, by any suitable chopping machine.

The sized, chopped and dried strands, at the moment of dispersing them in the white water, generally contain at least 99% glass by weight.

The chopped strands are then dispersed in the water, for example in a pulper. The aqueous solution in which the chopped strands are dispersed is called white water.

For passing the dispersion over the forming wire, the chopped strands, dispersed in the white water, may be present in an amount from 0.06% to 1% by weight, for example 0.1% to 1% by weight, of the sum of the weights of the strands and of the white water.

The chopped strands may firstly be dispersed in the white water in an amount from 0.5 to 10% by weight in the pulper, before then undergoing dilution, for example by ten times. However, it is also possible to produce a 0.05 to 1 wt % concentration of chopped strands right from the pulper and perform no dilution before the dispersion is sent on to the forming wire.

The white water may include a thickener for increasing the viscosity of the white water. This thickener may be present in an amount from 0 to 0.5% by weight in the white water. This thickener may, for example, be a hydroxyethylcellulose.

The thickener is preferably introduced in an amount such that the white water has a viscosity at 20° C. of between 1 and 20 mPa·s and preferably between 5 and 12 mPa.s.

The white water may include a cationic dispersant. This cationic dispersant may be present in an amount from 0 to 0.1% by weight in the white water. This cationic dispersant may, for example, be guanidine or a fatty-chain amine. In particular, the aerosol C61 sold by Cytec may be used.

The white water/chopped strand dispersion is stirred and then sent to a permeable forming wire allowing the white water to flow out through it and retaining the chopped strands on its surface. The white water may be sucked out in order to improve its extraction. The white water may be recycled in order to again be mixed with chopped strands. The chopped strands thus form a web on the surface of the forming wire. From putting the fibers in dispersion to passage over the forming wire, it is unnecessary to heat the white water/fiber mixture which is therefore always at approximately room temperature, that is to say a temperature ranging from 10° C. to 50° C., and even 18° C. to 30° C. Thus, the chopped strand/white water dispersion is in general permanently at a temperature ranging from 10° C. to 50° C., or even 18° C. to 30° C.

After passage over the forming wire, the step of applying the binder is carried out, the latter being generally in the state of an aqueous dispersion. This binder may be applied by dipping, between two forming wires, in which case the product held between the two wires is dipped into a bath by means of pairs of rollers, or it may be deposited on the web of chopped strands by a cascade, which means that the aqueous dispersion is poured onto the web of chopped strands in a stream perpendicular to said web and perpendicular to the direction in which said web runs. The binder is of the type of those normally used in this kind of production. It may especially be plasticized polyvinyl acetate (PVAc) or a styrene acrylic or a self-crosslinkable acrylic. The excess binder may be removed by suction through the forming wire. The binder is applied in an amount such that, after the heat treatment step, its content in the final mat is between 2 and 20% by weight and preferably between 3 and 6% by weight.

The purpose of the heat treatment step is to evaporate the water and to carry out the possible chemical reactions between the various constituents, such as for example the condensation of —OH groups. The heat treatment may be carried out by heating between 140 and 250° C. The duration of the heat treatment will generally be from 2 seconds to 3 minutes.

The strands that can be used within the context of the present invention generally comprise glass and are more particularly glass strands. The term “strand” is understood to mean an assembly of contiguous filaments comprising more particularly from 10 to 300 filaments.

The chopped strands may be stored before they are dispersed in the white water.

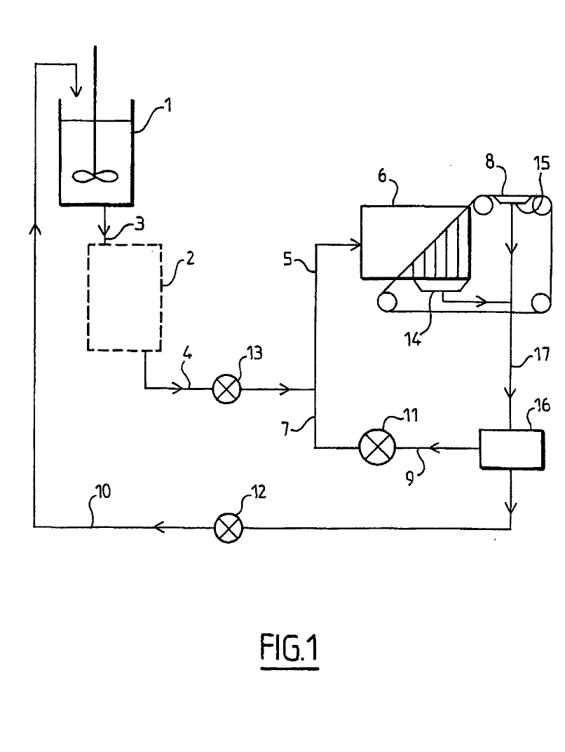

FIG. 1 shows schematically a process for the continuous preparation of a mat, after preparation of the chopped strands. The chopped strands are introduced into a pulper 1 in the presence of white water and with stirring, in an amount from 0.5 to 10% by weight and more generally from 1 to 5% by weight of chopped strands in the strand/white water mixture. Optionally, the mixture is then poured into a storage tank 2 via the line 3, the function of the storage tank being to increase the duration of mixing between the strands and the white water. This storage tank is optional. The mixture is then taken via the line 4 to the line 5, which combines the stream of mixture coming from the line 4 with a stream of recycled white water coming from the head box 6 via the line 7. At this point, the glass strand content in the strand/white water mixture is greatly lowered, for example by approximately 10 times. White water is drained at 14 and optionally sucked out at 15 through the forming wire 8 and is recycled via the line 17. This recycled water is then divided at 16, for example with about 10% being returned to the pulper via the line 10 and about 90% being returned to the head box 6 via the lines 9, 7 and then 5. Circulation in the lines is provided by the pumps 11, 12 and 13. The pump 11 is called the fan pump. The following, more conventional, steps of binder application and heat treatment are not shown in FIG. 1. The mat may be dried and then heat treated in a hot-air oven with circulation through the belt.

The invention allows the industrial manufacture of a chopped strand mat having a uniform mass per unit area of generally between 50 and 1100 g/m², especially about 225 or 300 or 375 or 450 or 600 or 900 g/m². The invention allows very uniform mats to be obtained, especially when they are of low grammage, that is to say between 70 and 150 g/m². The mat manufactured using the process of the invention is very uniform, which means that its mass per unit area may vary by less than 20%, for example less than 10%, or even less than 5%, over its surface. In the mat according to the invention, at least 80%, or even 90% by weight of the filaments are in the form of strand (assembly of contiguous filaments) comprising at least 10 filaments and even at least 25 filaments.

The mat according to the invention may be impregnated in what are called open-mold processes, such as hand lay-up processes, for the purpose of manufacturing composites, that is to say materials comprising a resin matrix surrounding fibers. The mat according to the invention is more particularly intended to be impregnated with a thermosetting resin, especially a polyester. The mat according to the invention leads to a composite that is remarkable from the following standpoints:
high translucency;
high bending strength, tensile strength and impact strength (especially unnotched Charpy impact strength).

### EXAMPLE 1

12 μm/30 tex P243 glass strands sold by Vetrotex were used, said strands being coated with a sizing comprising an organosilane and a film former of the polyvinyl acetate type plasticized by a dibutyl phthalate, said strands being chopped to 5 cm and dried so that they contained less than 0.2% water. These strands were used in the process shown in FIG. 1. The concentration in the pulper was 5 grams per liter. The concentration of glass strands on arrival at the forming wire was 0.075% by weight. The forming wire ran at a speed of 80 m/min, the flow rate of strand/white water mixture being poured onto the wire being 80 m³/hour. The white water contained 0.1% by weight of hydroxyethylcellulose and 0.025% by weight of cationic dispersant. After draining and suction of the excess water, the wet web sent to the binder application unit contained about 35% water by weight. The binder was an emulsion of PVAc plasticized by 40% of a polyester, poly(tetraethylene glycol adipate) (PTEGA) deposited so that the sum of the PVAC and the plasticizer represented 4% of the weight of the final mat. The web was then dried in a hot-air oven at 180° C. for 20 seconds. The mat obtained was very uniform since its mass per unit area varied by at most 5% of its surface (±2.5% relative to the average mass per unit area) by measuring the mass per unit area on 30 cm×30 cm specimens cut from the mat. Within the final mat, at least 80% by weight of the filaments formed part of strands comprising at least 25 filaments.

### EXAMPLE 2

The process was as in the case of example 1 except that a suspension of powder in water was used as binder. This suspension was obtained by mixing, into water, ethoxylated nonylphenol and a powder of a polyester polymer condensate of bisphenol propoxylated on fumaric acid, the particle size of which was 25 to 500 μm. The binder powder content retained on the final mat was also 4% by weight. The mat obtained was very uniform since its mass per unit area varied by at most 5% over its surface (±2.5% relative to the average mass per unit area) by measuring the mass per unit area on 30 cm×30 cm specimens cut from the mat. Within the final mat, at least 80% by weight of the filaments formed part of strands comprising at least 25 filaments.

1. A process for preparing a chopped strand mat, comprising:
dispersing, in a white water, chopped strands that are dried after sizing with a sizing liquid comprising an organosilane and a film former; then
forming a web by passing the dispersion over a forming wire through which the white water is drained, the strands being retained on said wire; then
applying a binder; and then
heat-treating.

2. The process as claimed in claim 1, wherein the dried chopped strands comprise less than 0.2% water by weight.

3. The process as claimed in claim 2, wherein the dried chopped strands comprise less than 0.1% water by weight.

4. The process as claimed in claim 1, wherein the film former has a molecular mass of between 10000 and 100000 and, after drying at 105° C. for 2 hours, has a solubility in acetone at 20° C. ranging from 50 to 95%.

5. The process as claimed in claim 1, wherein the strands have a length ranging from 20 mm to 110 mm.

6. The process as claimed in claim 1, wherein, on passing onto the forming wire, the strands are dispersed in white water in an amount from 0.06 to 1% by weight of the sum of the weights of the strands and of the white water.

7. The process as claimed in claim 6, wherein, on passing onto the forming wire, the strands are dispersed in white water in an amount from 0.1 to 1% by weight of the sum of the weights of the strands and of the white water.

8. The process as claimed in claim 1, wherein the white water comprises a thickener in an amount such that the white water has a viscosity at 20° C. of between 1 and 20 mPa.s.

9. The process as claimed in claim 8, wherein the white water comprises a thickener in an amount such that the white water has a viscosity at 20° C. of between 5 and 12 mPa.s.

10. The process as claimed in claim 1, wherein the binder is applied in an amount such that the mat comprises between 2 and 20% binder by weight.

11. The process as claimed in claim 1, wherein the binder is applied in an amount such that the mat comprises between 3 and 6% binder by weight.

12. The process as claimed in claim 1, wherein the heat treating step is carried out by heating between 140 and 250° C.

13. The process as claimed in claim 1, wherein the mat has a mass per unit area of between 50 and 1100 g/m².

14. The process as claimed in claim 13, wherein the mat has a mass per unit area of between 70 and 150 g/m².

15. The process as claimed in claim 1, wherein the strands comprise glass.

16. The process as claimed in claim 15, wherein, at the moment of their dispersion in the white water, the sized, chopped and dried strands contain comprise 99% glass by weight.

17. The process as claimed in claim 1, wherein the strands comprise 10 to 300 filaments.

18. The process as claimed in claim 1, wherein the chopped strand/white water dispersion is permanently at a temperature ranging from 10° C. to 50° C.

19. A chopped glass strand mat, wherein the mass per unit area of the mat varies by less than 20% over the surface of the mat and at least 80% by weight of the filaments comprised in the mat are in the form of strand comprising at least 10 filaments.

20. The mat as claimed in claim 19, wherein the mass per unit area varies by less than 10% over the surface of the mat.

21. The mat as claimed in claim 20, wherein the mass per unit area varies by less than 5% over the surface of the mat.

22. The mat as claimed in claim 19, wherein at least 90% by weight of the filaments are in the form of strand comprising at least 10 filaments.

23. The mat as claimed in claim 19, wherein at least 90% by weight of the filaments are in the form of strand comprising at least 25 filaments.

24. The mat as claimed in claim 19, wherein said mat has a mass per unit area of between 50 and 1100 g/m².

25. The mat as claimed in claim 24, wherein said mat has a mass per unit area of between 70 and 150 g/m².
